(19) United States
(12) Patent Application Publication
(10) Pub. No.: US 2026/0284985 A1
(43) Pub. Date: Sep. 24, 2026

(54) SOLVENT-FREE PROCESS AND PRODUCT OBTAINED

(71) Applicant: ALCANTARA S.P.A., Milano (IT)

(72) Inventors: Ryuji Shikuri; Takaya Nishida; Saverio Angelucci, Milano (IT); Walter Cardinali, Milano (IT); Elena Fortunati, Milano (IT); Giovanni Addino, Milano (IT)

(73) Assignee: ALCANTARA S.P.A., Milano (IT)

(21) Appl. No.: 19/475,458

(22) PCT Filed: Apr. 16, 2024
(86) PCT No.: PCT/IB2024/053697

§ 371 Date: Oct. 15, 2025

(30) Foreign Application Priority Data
Apr. 18, 2023 (IT) 102023000007491

(51) Int. Cl. B29C 70/36; B29C 70/12; B29K 75/00; B29K 105/12; D06N 3/00; D06N 3/14

(52) U.S. Cl. CPC B29C 70/36; B29C 70/12; D06N 3/0004; D06N 3/0011; D06N 3/14; B29K 2075/00; B29K 2105/122; B29K 2105/128

(57) ABSTRACT

The invention relates to a process for the preparation of a water-based nonwoven microfibre fabric, comprising the steps of: 1) impregnating a fibrous material comprising ultra-fine fibre-generating fibres with an aqueous dispersion containing polyurethane, an inorganic salt containing monovalent or bivalent positive ions and a cross-linking agent (first impregnation), wherein the polyurethane content is between 15% and 40% by mass relative to the mass of the ultra-fine fibres; 2) fixing the polyurethane onto the impregnated fibrous material (first coagulation step); 3) generating ultrafine fibres from the ultra-fine fibre-generating fibres to form a microfibrous material consisting of ultra-fine fibres, by treating the fibrous material with an alkaline, acid or neutral aqueous solution; and 4) impregnating the microfibrous material with an aqueous dispersion containing polyurethane, an inorganic salt containing monovalent or bivalent positive ions and a cross-linking agent, in which the polyurethane is between 15% and 40% by mass relative to the mass of the ultra-fine fibres (second impregnation); 5) fixing the polyurethane onto the impregnated fibrous material (second coagulation step), wherein, the ratio of the polyurethane content of the second impregnation to the polyurethane content of the first impregnation is between 100 and 250%, preferably between 105 and 240%. The invention also relates to new nonwoven suede-like fabric obtained with the solvent-free process of the invention which has a good feel (good hand), high elasticity, excellent resistance to yellowing and high durability. The nonwoven suede-like fabric can be used to make products for the fashion industry (for example for clothing and accessories) and automotive industry (for example products for vehicle interiors, in particular for car seats, panels and ceilings).

### FIELD OF THE INVENTION

The present invention relates to a process for the preparation of a nonwoven synthetic microfibre suede-like fabric, which does not require the use of an organic solvent. The invention also relates to a nonwoven suede-like fabric obtained with the process of the invention which has a good feel (good hand), high elasticity, excellent resistance to yellowing and high durability. The nonwoven synthetic microfibre suede-like fabric can be used to make products for the fashion industry (for example for clothing and accessories) and automotive industry (for example products for vehicle interiors, in particular for car seats, panels and ceilings)).

### BACKGROUND OF THE INVENTION

There is a known method in the prior art for the preparation of a nonwoven microfibre suede-like fabric obtained from so-called “islands-in-a-sea” fibres. According to this technique, a bicomponent fibre is prepared which consists of a component called “island” completely surrounded by another component called “sea”, easily removable with solvents. “Islands-in-the-sea” fibres are obtained by feeding the two polymeric components to a spinneret (as described, for example, in U.S. Pat. Nos. 3,692,423, 3,899,292, and 3,531,368). The fibres thus obtained are then used to prepare a felt by needle-punching or a high-pressure water jet; the felt is then subjected to various steps of impregnation in aqueous solutions and organic solvents to fix the fibres and/or remove the various components. For the preparation of a nonwoven fabric with a suede-like appearance, the felt obtained by needle-punching or a high-pressure water jet undergoes a first impregnation with an aqueous solution of polyvinyl alcohol (PVA), followed by removal of the “sea” component by dissolution in a solvent such as trichloroethylene (EP1323859). The intermediate microfibrous product thus obtained undergoes a second impregnation with a polyurethane (PU) solution in an organic solvent (for example DMF). Finally, after one or more cleaning treatments, the PVA is removed and the resulting product undergoes a finishing process comprising a cutting step followed by polishing and dyeing. The recovered PVA can be reused in the process or it can be sold for various applications. There are also known solvent-free methods for the preparation of nonwoven fabrics, which include the formation of sea/island fibres and subsequent impregnation of the resulting felt with PVA and PU (EP1243691). The use of water in place of conventional organic solvents (for example, dimethylformamide-DMF- and trichloroethylene) constitutes a significant advantage from a cost savings, worker health protection and environmental standpoint. Nonwoven fabrics obtained with solvent-free methods maintain the same characteristics in terms of consistency and resistance as those obtained with solvent-based methods, besides having excellent resistance to yellowing, high durability, flexibility, elasticity, and good consistency.

WO2019025964 describes a method for the preparation of a nonwoven microfibre suede-like synthetic fabric which does not require the use of an organic solvent and comprises the steps of: a) preparing a bicomponent fibre of the “islands-in-the-sea” type, wherein the sea component is a polymer removable in hot water or an alkaline aqueous solution; b) preparing a felt by needle punching of the bicomponent fibre of the “islands-in-the-sea” type; c) hot impregnation of said felt with an aqueous solution of polyvinyl alcohol (PVA) having a degree of saponification of at least 94%, optionally with a water-soluble organic or inorganic salt added to it; d) removal of the sea component from the PVA-impregnated felt obtained in step c) by contact of the felt with a basic aqueous solution of an alkali or alkaline earth hydroxide, thereby obtaining a microfibrous intermediate product; e) washing the microfibrous intermediate product of step d) with neutral water containing a water-soluble organic or inorganic salt or with acidic water or, if the aqueous solution of polyvinyl alcohol (PVA) of step c) has had a water-soluble organic or inorganic salt added to it, with neutral water; f) cold impregnation of the microfibrous intermediate product as per step e) with a polyurethane (PU) dispersed in water containing viscosity-regulating additives and optional hydrosoluble substances; g) fixing the PU to the microfibrous intermediate product by coagulation of the PU dispersion and subsequent drying. The fixing can take place by coagulation in air at a high temperature, coagulation in hot water, coagulation in an aqueous solution of an electrolyte, high-frequency coagulation, microwave coagulation, ultrasonic coagulation, coagulation by IR (infrared) radiation or steam coagulation; h) removal of the PVA added in step c), of the salt optionally added in step c) and/or e) and of the additives added in step f); i) subjecting the material thus obtained to cutting, sanding on one or both sides, and dyeing.

The pure PVA or PVA containing salts used in step c) is characterised by a water solubility that is significantly lower than the solubility of the “sea” component of the bicomponent fibre under dissolution conditions. The methods of the invention provide for the use of PVA with a high degree of saponification: the degree of saponification reaches insolubility in an aqueous environment so that the PVA can withstand the subsequent treatment to remove the sea component (step d) without prejudicing its dissolution in water in step h). The solubility of the PVA is obtained not only by using PVA with a high degree of saponification and, alternatively, by adding salts, but also by using a high-temperature thermal treatment (also known as thermal polymerisation) carried out at the end of step c) of impregnation with PVA and subsequent drying. In this manner, the PVA can be fixed stably to the felt and the subsequent steps of removing the “sea” component are carried out without substantially altering the content and distribution of PVA in the material.

However, all the above-described processes are costly from an energy standpoint, they are processes made up of numerous steps and involve auxiliary raw materials, such as PVA, which, after removal, require recovery and/or disposal, with further steps and costs. Moreover, the thermal/crystallisation steps entail a high energy consumption.

There are other known methods in the prior art that use the hot water coagulation approach. EP3112530 regards an invention relating to an environmentally sustainable, solvent-free method for the production of a product that is comparable, in terms of uniformity of feel, to products made of artificial leather obtained with an organic solvent-based polyurethane. The article described in EP3112530 comprises a microfibrous material formed from ultra-fine fibres and, as a binder, a polymeric elastomer with a hydrophilic group. The process comprises a step of adding, to a microfibrous material, a polymeric elastomer, polyurethane, dispersed in water, a thermosensitive coagulant, and a thickening agent capable of improving the viscosity of the formulation; subsequently there is a step of coagulating the polymeric elastomer in hot water at a temperature comprised between 50° C. and 100° C. The drawback of this process is the dispersion of polyurethane in the coagulation tank, which obstructs the piping system and requires frequent cleaning.

EP1353006 describes a method for the preparation of nonwoven fabrics in which both impregnation steps are carried out using PU in place of other auxiliary raw materials (in the first impregnation it is used in place of PVA), both in an aqueous solution and in an organic solvent. According to this patent, the fixing of the polyurethane is carried out by means of a saturated water vapour treatment and microwave/radiofrequency drying or by means of an acid or saline aqueous solution. Classic drying by air convection is not used, as it causes the migration of the aqueous polyurethane emulsion towards the external edges of the felt and does not impart any porosity to the fixed polyurethane, given the extreme slowness of the treatment, thus compromising the characteristics of the finished product. The fixing technologies applied in the process described in this document are in general more costly in terms of energy consumption and investment in machinery. Furthermore, the wet coagulation in contact with acid or saline aqueous solutions requires additional equipment dedicated to treating the water of the coagulation solution prior to drainage.

EP4079961 relates to a method for the production of a material which comprises the following steps (1) to (3) in this order:
(1) a first step of impregnating a felt consisting of ultra-fine fibre-generating fibres, with an aqueous dispersion containing an elastomeric precursor having a hydrophilic group, an inorganic salt containing a monovalent cation and a cross-linking agent; the microfibrous material impregnated with the aqueous dispersion is then subjected to a hot drying treatment at a temperature of between 100° C. and 180° C. The content of the inorganic salt containing monovalent cations in the aqueous dispersion is between 10 parts by mass and 100 parts by mass relative to 100 parts by mass of the elastomeric precursor;
(2) a step of generating ultra-fine fibres, which consists in generating ultra-fine fibres from the ultra-fine fibre-generating fibres to form a microfibrous material consisting of ultra-fine fibres; and
(3) a second step of impregnating the microfibrous material consisting of ultra-fine fibres with an aqueous dispersion containing an elastomeric precursor containing a hydrophilic group, an inorganic salt containing monovalent cations and a cross-linking agent; the microfibrous material impregnated with the aqueous dispersion then undergoes a hot drying treatment at a temperature of between 100° C. and 180° C. The content of the inorganic salt containing monovalent cations in the aqueous dispersion is between 10 parts by mass and 100 parts by mass relative to 100 parts by mass of elastomeric precursor.

In the process of EP4079961, the step of generating the ultra-fine fibres requires dissolution conditions that are very severe in terms of time, temperature and concentration of alkalis (30 minutes, 95° C., 8 g/l); it is thus a high energy consuming process, difficult to apply in industrial production. Furthermore, the total amount of elastomeric resin relative to the ultra-fine fibres is very low (less than half of what is present in the material of the present invention); therefore, the final appearance of the material is more similar to a fabric than to a suede leather of the nonwoven fabric type.

The object of the present invention is of provide a solvent-free process making it possible to obtain a nonwoven microfibre suede-like fabric that possesses the same properties of softness (hand), elasticity, resistance to yellowing and abrasion resistance as nonwoven suede-like fabrics obtainable with the classic solvent-based process.

Compared to the “solvent-free” processes illustrated above, the process of the present invention allows decided energy savings and a containment of equipment investment costs tied to the use of simpler, more compact lines.

### SUMMARY OF THE INVENTION

The present invention relates to a process for the production of a nonwoven microfibre fabric, comprising the steps of:
1) impregnating a fibrous material comprising ultra-fine fibre-generating fibres with an aqueous dispersion containing polyurethane, an inorganic salt containing monovalent or bivalent positive ions and a cross-linking agent (first impregnation), wherein the polyurethane content is between 15% and 40% by mass relative to the mass of the ultra-fine fibres;
2) fixing the polyurethane onto the impregnated fibrous material (first coagulation step);
3) generating ultra-fine fibres from the ultra-fine fibre-generating fibres to form a microfibrous material consisting of ultra-fine fibres, by treating the fibrous material with an alkaline, acid or neutral aqueous solution; and
4) impregnating the microfibrous material with an aqueous dispersion containing polyurethane, an inorganic salt containing monovalent or bivalent positive ions and a cross-linking agent, in which the polyurethane is between 15% and 40% by mass relative to the mass of the ultra-fine fibres (second impregnation);
5) fixing the polyurethane onto the impregnated fibrous material (second coagulation step).

Preferably, the ratio of the polyurethane content of the second impregnation (step 4) to the polyurethane content of the first impregnation (step 1) is between 100 and 250%, preferably between 105 and 240%.

Preferably, the concentration of the monovalent or bivalent positive ions in both the first and second impregnation is between 10 and 100% by mass relative to the mass of the polyurethane.

The invention also relates to a nonwoven microfibre suede-like fabric obtained with the process of the invention, wherein the nonwoven fabric comprises:
(i) a microfibrous material comprising ultra-fine fibres in which the average diameter of a single fibre is between 0.1 μm and 10.0 μm, and polyurethane; and in which
(ii) any cross section transverse to the thickness of the microfibrous material has a plurality of regions occupied by the polyurethane that are in contact with the section being observed, each having a cross-sectional area≥50 μm² (independent regions), the total area of the independent regions being between 5.5% and 40.0% of the total field of view.

### BRIEF DESCRIPTION OF THE FIGURES

Additional features and advantages of the invention will be illustrated below, also with reference to the appended figures, in which:

FIG. 1 shows the structure of a nonwoven microfibre fabric obtained with a known process based on impregnation with polyurethane in a solvent followed by coagulation to obtain a porous structure. This product represents the current reference in terms of appearance, feel, mechanical properties and abrasion resistance;

FIG. 2 shows the structure obtained with the known solvent-free methods in which aqueous polyurethane formulations are used in combination with wet coagulation; the structure obtained is different from the nonwoven fabric shown in FIG. 1, obtained with solvent-based methods;

FIG. 3 shows the structure of a nonwoven microfibre fabric obtained with the process according to the invention. The structure is different from the one in FIGS. 1 and 2 and is obtained using aqueous polyurethane formulations in combination with coagulation by warm air, with the claimed parameters in terms of polyurethane content.

FIG. 4 shows the regions occupied by the polyurethane in the cross section transverse to the thickness of the microfibrous material.

FIG. 5 shows the results obtained with examples 1-6 according to the invention and the comparative examples 7-13.

### DETAILED DESCRIPTION OF THE INVENTION

The impregnation step 1) is preceded by a step a) of spinning a bicomponent fibre of the sea-island type and a step b) of preparing a fibrous material from the bicomponent fibre; and a step c) of thermal stabilisation of the fibrous material with the bicomponent fibre.

According to step a), a bicomponent fibre is spun by combining two different polymers called “island” (polymer which forms the microfibres) and “sea” (polymer enveloping the microfibres). The bicomponent fibre is spun by means of a spinneret and this makes it possible to obtain a composite fibre in which one of the polymers (sea) is arranged around a microfibre of the other polymer (island). The fibre thus obtained is treated according to the finishing methods known in spinning technology; in particular the bicomponent fibre, before being pressed, preferably has a titre of between 5 and 30 denier, more preferably between 10 and 25 denier. The “island” component is a polymer selected from the group consisting of: polyethylene terephthalate (PET), copolyesters containing both terephthalic acid and isophthalic acid and ethylene glycol, modified polyesters (such as polytrimethylene terephthalate-PTT, polybutylene terephthalate-PBT, etc.), polyesters dyeable with cationic dyes, polyamides, polyethylene (PE), polypropylene or other types of polyolefins, polyhydroxyalkanoates (PHA), polyhydroxybutyrates (PHB), polyethylene furanoate (PEF) and polylactic acid (PLA). The polymer can be produced from raw materials originating from renewable sources (which completely or partially replace the current fossil raw materials) or through the action of microorganisms that transform raw materials originating from renewable sources. Examples of polymers that can also be produced from raw materials originating from renewable sources are PTT, PEF, PET, PLA, and PE. Examples of polymers obtained from microorganisms are PHA, PHB and copolymers thereof. Chemically or mechanically recycled polymers can also be considered. Chemically recycled polymers, produced by depolymerisation of other polymers or end-of-life materials, purification of monomers and second polymerisation, are preferable because the purity and performance are more similar to those of the virgin material. However, the energy consumption and environmental impact of their production are high. Mechanically recycled polymers are preferable for their low environmental impact, but their mechanical performance may be inferior due to the impurities that remain in the polymer after the recycling process. PET, which can be obtained both from fossil raw materials and renewable raw materials, and can ultimately be recovered through (chemical and mechanical) recycling processes, is particularly preferred in order to obtain a final nonwoven fabric with superior performance in terms of light fastness and mechanical properties.

One example of a sea component is a polymer selected from the group consisting of: polyvinyl alcohol (PVA), polystyrene (PS), copolymers of polystyrene containing PVA (co-PVA-PS), copolymers of polystyrene containing maleic anhydride or other organic monomers (co-PS), copolyesters containing PVA (co-PVA-PES) or polyethylene glycol (co-PEG-PES), co-polyolefins, such as polyethylene or polypropylene containing PVA (respectively co-PVA-PE, co-PVA-PP), copolyesters containing a blend of terephthalic acid, isophthalic acid and 5-sulfoisophthalic acid and copolyesters containing both terephthalic acid and 5-sulfoisophthalic acid or a sodium salt thereof (co-PES, which can also be abbreviated with the acronym TLAS), the latter being particularly preferred. Chemically or mechanically recycled polymers (which completely or partially replace the current fossil raw materials) can also be taken into consideration. The polymers can also be produced from combinations of fossil sources and renewable sources and can be biodegradable to facilitate their disposal after use (compostable polymers).

The ratio of the island component to the sea component of the bicomponent fibre is such as to enable rapid, efficient spinning of the two components by means of a spinneret. The island/sea ratio is preferably between 20:80 and 90:10, more preferably between 50:50 and 90:10. Island/sea ratios of less than 50:50 increase the amount of sea component to be removed, with a consequent increase in the production cost, and result in a net loss of the physical-mechanical properties of the fibre. Furthermore, the finished nonwoven fabric finito has a poor-quality appearance due to the low density of fibres on the surface. Island/sea ratios greater than 90:10 cause difficulty in the separation of islands from one another during spinning (difficulty of producing an island/sea bicomponent fibre) and in the consequent production of microfibres after removal of the sea component.

Both the sea component and the island one can be blended with other agents selected from: pigments for the island component and incompatible polymers for the sea component. Incompatible polymers (i.e. immiscible or partly miscible with the sea component) produce a heterogeneous system which, on a microscopic level, shows areas dispersed in the matrix formed by the sea polymer, in which only one of the polymers is present. In general, these systems are fragile and if they are used to form the sea component, they facilitate the breakage of the casing during the pressing and felt production steps. The PVA added to the co-PES and polyethylene glycol (PEG) added to the PS and co-PS can be mentioned as particularly efficient polymers incompatible with the sea component.

UV stabilisers and fillers of micro or nano dimensions can be inserted into the island component; carbon black or carbon-based fillers are particularly preferred because they allow for reducing the amount of dye used during the dyeing step in the case of production of nonwoven fabrics belonging to ranges of dark colours, greys, and blacks. The UV stabilisation properties of carbon-based fillers, combined with the reduction in the dye used in the final dyeing step, make it possible to reduce the deterioration of the colour on exposure to UV rays. If it is not possible to use carbon black (for example in the event that it is desired to produce nonwoven fabrics with very light and bright colours), the use of UV stabilisers or coloured pigments with high light fastness make it possible to increase the light fastness of the dyed materials. However, dyes, especially if they consist of pigments and molecules with high light fastness, usually have a large impact on the final cost of the product.

Before the fibrous material is prepared according to step b), the bicomponent fibre is treated with methods known in the art which provide for the addition of lubricant oils in the pressing step to improve the orientation of the macro molecules in an axial direction and the corresponding physical-mechanical properties, as well as to reduce the titre of the fibres thus obtained. This characteristic is particularly in demand for the production of high-quality fibres.

The pressing ratio can generally vary in the range of 2 to 8, preferably in the range of 2.5 to 5, with a final titre of the bicomponent fibre between 2 and 8 denier (2.2-8.9 dtex) and a titre of the island component in the range of 0.001 to 0.5 denier (0.001-0.56 dtex). The diameter of the microfibres after pressing is between 0.1 and 10 microns. The bicomponent fibre, once pressed, is crimped with specific apparatus until obtaining a number of curls of between 4 and 15 per centimetre and it is subsequently cut into staples between 40 and 60 mm long, preferably between 45 and 55 mm; these operations facilitate the subsequent fibrous material production step (step b)).

In a preferred embodiment of the invention, the fibre, before being pressed, has a titre between 5.5 and 19 den, preferably between 7.0 and 15 den. Furthermore, the pressing is carried out in ratios that generally range between 2 and 5, preferably between 2.1 and 4.5. At the end of the pressing step, the fibre is cut to produce a staple fibre with a length of between 45 and 55 mm.

In the process of the present invention, the preparation of the fibrous material according to the step b) takes place by needle punching of a staple from the sea/island bicomponent fibre obtained in step a). The felt can also be produced with high-pressure water jet spunlace technology.

In a particularly preferred embodiment, the fibrous material of step b) is obtained by needle punching of a bicomponent fibre formed from PET and TLAS (optionally containing pigments in the island component and/or incompatible polymers in the sea component), cut into staples of about 51 mm.

After step b), one obtains a fibrous material with a thickness preferably between 2 and 4 mm and an apparent density between 0.1 and 0.5 g/cm³, more preferably between 0.15 and 0.35 g/cm³. Advantageously, such density and thickness values are optimal for obtaining a final nonwoven product endowed with a good hand, softness, elasticity, appearance, and mechanical resistance to the process conditions. A felt density of less than 0.1 g/cm³ provides a final product with a poor-quality appearance and poor mechanical properties; on the other hand, a felt density greater than 0.5 g/cm³ produces a heavy final product that is hard to the touch.

After step b) of preparing a microfibrous material, one proceeds with a thermal stabilisation treatment (step c)). The aim of this step is to stabilise the intermediate fibrous material before the impregnation step (step 1)) and to increase the density of the fibres to improve the appearance of the final properties.

The thermal stabilisation treatment of the felt according to step c) can be carried out with hot water between 70° C. and 95° C., preferably between 80-90° C.

The density of the felt, once “dimensionally stabilised” by means of the thermal treatment (hot water), is preferably between 0.25-0.50 g/cm³, more preferably between 0.30-0.45 g/cm³, with a thickness of between 1.5-3.5 mm, in order to obtain a final nonwoven fabric with good softness.

In a preferred embodiment, with the final objective of reducing costs, the step of thermally treating the fibrous material (step c)) and the first impregnation (step 1)) can be carried out in a single step.

The first and second impregnation with polyurethane (PU) containing hydrophilic groups (steps 1) and 4)) are carried out with an emulsion/aqueous dispersion of polyurethane.

The emulsion/aqueous dispersion of PU used for the first and second impregnation can be the same or differ in type and/or the amount of polymer PU, as well as in the type of additives added to the formulation.

In the first impregnation, use is made of a polyurethane dispersion in which the polyurethane is present in a concentration of between 5 and 20% by weight, preferably between 6 and 18% by weight at room temperature, which generates an amount of polyurethane between 15% and 40%, preferably between 18% and 35% by mass relative to the mass of the ultra-fine fibres of the impregnated material.

By regulating the amount of PU applied in the first impregnation step within the specified range, it is possible for the PU to adequately retain the fibres and for the dimension of the fibrous material to be maintained during the process of removal of the sea component. If the PU content in the first impregnation is less than 5%, the fibrous material will undergo excessive morphological changes in the process of removal of the sea component, thus impairing the quality of the surface appearance and the abrasion resistance of the final nonwoven fabric.

On the other hand, if the PU content exceeds 20% in the first impregnation, the excessive presence of PU will hinder adequate removal of the sea component. As a consequence, the surface of the final nonwoven fabric will become irregular and the product will not be soft.

The polyurethane applied to the fibrous material in the first impregnation must withstand all the other production steps (conditions of dissolution of the sea component, resistance during the second impregnation step, high-temperature acidic and basic treatments during the dyeing process), up to the final dyed product. For this reason, the polyurethane must undergo a coagulation/fixing step. Furthermore, once fixed, the polyurethane must have good durability characteristics in terms of resistance to hydrolytic conditions and UV degradation. Preferably, an inorganic salt is added to the polyurethane dispersion.

The salts added to the polyurethane formulation can be monovalent or bivalent cationic inorganic salts (salts of alkali and alkaline earth metals). Both types are effective in thermal destabilisation of the polyurethane during the impregnation steps 1) and 4). Monovalent cationic salts, such as sodium sulphate and sodium chloride, are particularly preferred for their process of thermal destabilisation, which facilitates the control of destabilisation during the fixing steps 2) and 5).

When bivalent cations like magnesium sulphate or calcium chloride are added, even small differences in the amount added influence the stability of the aqueous dispersion, so it is difficult to strictly control the gelation temperature. An inorganic salt containing monovalent cations, by contrast, since it has a small ionic valency, has a relatively limited influence on the stability of the aqueous dispersion. In this manner, the amount of additive is regulated and the gelation temperature of the aqueous dispersion can be strictly controlled, while simultaneously ensuring the stability of the aqueous dispersion.

An inorganic salt containing monovalent cations allows a thermosensitive coagulability to be imparted to the aqueous dispersion, with a greater control over the process. In the present invention, “thermosensitive coagulability” refers to the property of diminishing the fluidity of the aqueous dispersion and coagulating the aqueous dispersion after the reaching of a certain temperature (called gelation temperature or “cloud point”) at the time of heating the aqueous dispersion.

The concentration of salt is between 30 and 100%, preferably between 40 and 80% of the solid weight of the polyurethane. When the amount is greater than 30%, the ions present in a large amount in the aqueous dispersion act uniformly on the polyurethane particles, so coagulation can be completed rapidly at a specific gelation temperature. Consequently, the coagulation of the polyurethane can proceed in a state in which a large amount of moisture is contained in the fibrous material, thus obtaining a good flexibility and sensation of elasticity similar to that of natural leather. If the salt content is greater than 100% by mass, adhesion with the fibres becomes poor and the deterioration of the physical properties is rather high. Furthermore, the stability of the aqueous dispersion is rather poor.

The preferred inorganic salt is sodium sulphate.

The dissolved electrolytes enable the subsequent coagulation of the polyurethane to be carried out at a low temperature (i.e. a temperature no higher than 70° C.), with considerable energy savings.

Step 3) of generating ultra-fine fibres from the ultra-fine fibre-generating fibres to form a microfibrous material consisting of ultra-fine fibres represents the step of removing the sea component. By way of example, it is possible to use an aqueous sodium hydroxide solution or aqueous alkaline solutions, an aqueous acid solution or hot water. The aqueous sodium hydroxide solution preferably has a concentration of between 4 and 10% by weight, preferably 5-8%.

Preferably, the treatment temperature is between 50 and 75° C., preferably between 60 and 70° C.; the time for dissolving the sea component ranges between 4 and 40 minutes. The dissolution conditions are optimised to selectively dissolve the sea component in as little time as possible, while seeking to remove the least possible amount of polyurethane and of the island component in order to reduce the deterioration of the microfibrous material.

One embodiment provides for washing with water at room temperature at the end of step 3) to avoid partially dissolving the “island” component, in the event that aggressive aqueous acid or basic solutions are used.

The microfibrous material from which the sea component was extracted is subjected to a second impregnation (step 4)) with an aqueous polyurethane dispersion having a concentration ranging between 5% and 20%, preferably from 7 to 20% at room temperature, which generates an amount of polyurethane between 15% and 40%, preferably between 20% and 40% by mass relative to the mass of the ultra-fine fibres of the impregnated intermediate. If the PU concentration is less than 5%, the PU cannot maintain its voluminosity during the coagulation step and cannot be evenly distributed. If, on the other hand, the PU concentration exceeds 20%, the PU will retain the fibres excessively, with a consequent loss of softness.

If the PU/PET ratio is less than 15%, the fibres will not be sufficiently retained by the PU and the distribution of the PU will become uneven, with a consequent poor-quality appearance and deterioration of abrasion resistance. If, on the other hand, the PU/PET content exceeds 40%, the PU will block the fibres excessively, with a consequent lack of softness and lack of uniformity of the surface of the product.

In order to obtain a final product with characteristics of softness and an appearance similar to those of products obtained with traditional processes that use organic solvents or a single step of impregnation with PU, the ratio of the PU content of the second impregnation (step 4)) to the PU content of the first impregnation (step 1)) must be between 100-250%, preferably 120-240%. The PU applied with the first impregnation is not necessary for abrasion resistance, whilst the PU applied in the second impregnation is not influenced by the alkaline treatment in the process of removing the sea component and adheres directly to the ultra-fine fibres, thus contributing considerably to the abrasion resistance and hand of the product. Too low an amount of polyurethane in the second impregnation step (ratio of the PU content less than 100%) produces a final product with poor properties of abrasion resistance and poor mechanical properties due to the poor adhesion between the polyurethane and the fibres (the PU applied with the first impregnation is not sufficient to retain all the fibres during the dissolution step); on the other hand, a ratio of the PU content greater than 250% could be responsible for the low resistance of the material during step 3) of removal of the sea component, thus generating a final nonwoven fabric with a poor-quality appearance due to the short length of the nap, which renders the appearance of the final product different from that of suede-like artificial leather. Furthermore, the surface feel of the material becomes stiffer and rougher.

Moreover, the distribution of polyurethane in the nonwoven fabric section (along the thickness of the material) must be present mainly in the central zone and not towards the external edges. This optimal distribution of the polyurethane can be ensured using double impregnation with polyurethane and an appropriate ratio of the PU content and salt, as indicated above.

As is well known, PU is a polymer with a polymeric chain made up only of urethane bonds (i.e. —NH—(CO)—O—) or a mixture of urethane and urea bonds (i.e. —NH—(CO)—NH—) and is prepared by reaction between a polyol or a mixture of polyols and a diisocyanate. To facilitate the polymer's dispersion in water, it may be useful to add ionomers (molecules containing ion groups that bind like polyols to isocyanate). In the present invention, the PU is preferably obtained from the reaction of an aliphatic or aromatic diisocyanate with polyols having an average molecular weight of between 500 and 5000 Da, preferably selected from: polyether, polyester, polycarbonate, and polyether-polycarbonate. Use can also be made of polyols obtained from fatty acid dimerization processes or polymerisation of olefins, which enable functionalities with high hydrophobicity to be introduced into the chain to increase the polyurethane's resistance to hydrolysis processes and increase the total content of raw materials from renewable sources present in the final product (there are already known processes for the production of simple olefins or ethers/esters through fermentation processes and subsequent unsaturation). It is also possible to include polydimethylsiloxanes in the reaction to obtain hybrid PUS, in order to enhance the mechanical properties and resistance to hydrolysis. It is possible to add small amounts of trifunctional monomers to the polyurethane chain or to chain terminals of an aminosilane type during the process of synthesis to increase the polymer's resistance to hydrolysis, once applied and subjected to cross-linking.

The aforesaid raw materials can be obtained through production processes that use first-generation renewable sources (from food products), second-generation renewable resources (agricultural or industrial waste) or third-generation renewable resources (direct synthesis from CO₂). Some raw materials may further be obtained from chemical recycling processes (hydrolysis, monomer purification and new synthesis) or physicochemical recycling processes (microfibre separation from polyurethane through the use of solvents or selective hydrolysis of the microfibre and recovery of the polyurethane fraction).

Impregnation with PU can take place in the presence of additives such as, for example, surfactants, destabilising agents, other alkali metal salts or alkaline earth salts, generators of acids that release protons when they are heated, such as, for example, diethylene glycol acetate or diethylene glycol formate, water-repellent agents, plasticising agents, wetting agents and dispersants, silicone compounds and nanoparticles, nanofibres and nanotubes dispersible in water, preferably in an amount of between 0 and 15%, more preferably between 0 and 8% relative to the PU. It is possible to add clays (natural ones such as montmorillonite or synthetic ones such as laponite) or other silicates to modify the rheological behaviour and coagulation behaviour of the formulation.

Following the impregnation steps 1) and 4), the intermediate (micro)fibrous product is subjected to the PU fixing steps 2) and 5). The fixing can take place by air coagulation, hot water coagulation, coagulation in aqueous solutions of electrolytes, radiofrequency coagulation, microwave coagulation, ultrasonic coagulation, coagulation by IR (infrared) radiation or steam coagulation. Preferably, hot air coagulation is used, thereby obtaining the fixing of the PU by thermal means, or the coagulation can be obtained with aqueous solutions containing salts (such as, for example, salts of alkali and alkaline earth metals) or acids that destabilise the dispersion (for example organic acids such as formic acid, acetic acid, propionic acid, oxalic acid, malonic acid, succinic acid, maleic acid, and fumaric acid, or inorganic acids such as hydrochloric acid, sulphuric acid and phosphoric acid).

Hot air coagulation is particularly economical, being achieved by using an air circulation oven.

If a salt is used in the polyurethane dispersion, after the step of fixing the polyurethane it is preferable to carry out a washing step to remove the excess salt. It is possible to carry out a washing with water at room temperature.

After its removal from the intermediate, the salt can be recovered and purified with the objective of using it again in the production process, thus making the process more sustainable (circular economy approach).

In the present invention, if salt is used in the PU solution, the fixing step 2) takes place by air coagulation, which is capable of inducing destabilisation of the PU during drying using less thermal energy. In the case of air coagulation of a PU emulsion containing salt, the dissolved electrolytes allow for obtaining coagulation of the polyurethane at a low temperature (i.e. at a temperature no higher than 70° C.), with considerable energy savings. When hot air coagulation of the PU is applied in the presence of a salt (preferably sodium sulphate), the structure of the PU after the coagulation process becomes particular and different from the one obtained by coagulation with a solvent or coagulation with water, making it possible to produce a soft material with an appearance and feel similar to those of conventional artificial leather obtained with solvent-based processes.

In the case of hot air coagulation in the fixing step 5), the material obtained after the second impregnation is placed in contact with air at a temperature of between about 50° C. and about 200° C., preferably between about 50° C. and 160° C. in order to better control the migration of the polyurethane during heating; the duration of heating can vary, for example, according to the type of polyurethane used, since, if polyurethanes that coagulate thermally are used, it is possible to limit the heating of the impregnated intermediate product, thus avoiding complete drying and saving on the amount of energy necessary to evaporate the water present. Preferably, the PU is coagulated on the microfibrous intermediate product in an oven at increasing temperatures between 50° C. and 160° C. This temperature gradient prevents the water from evaporating so fast as to also bring the solid part of the dispersion to the surface before it receives sufficient heat to degrade any surfactants present which stabilise the PU.

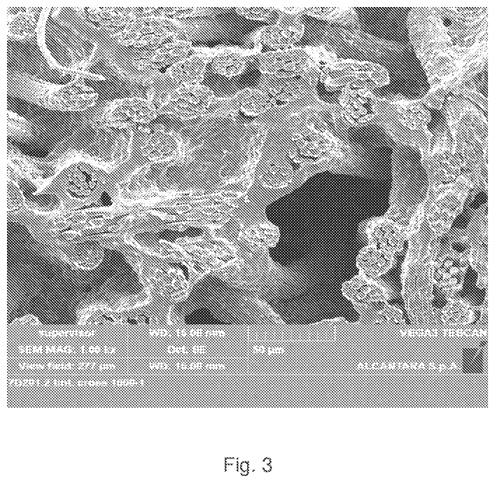

Hot air coagulation makes it possible to obtain a finished product endowed with excellent resistance and durability. The structure of the PU obtained by applying the hot air coagulation process in the presence of a salt (preferably sodium sulphate) has a particular porosity (FIG. 3) that makes the final product very soft and gives it an appearance similar to that of materials obtained with the classic solvent-based process, thanks to the particular combination between porosity and adhesion to the fibre, without prejudicing the physical-mechanical properties.

In the case of coagulation in an aqueous solution containing dissolved electrolytes (salts and acids), it is possible to obtain coagulation of the polyurethane at a low temperature (i.e. at a temperature no higher than 70° C.), with considerable energy savings. In this case, the impregnated intermediate product obtained after the second impregnation is placed a contact, preferably by immersion, with water at a temperature of between about 20° C. and 90° C., preferably between about 40° C. and 80° C., containing a certain amount of a PU dispersion destabilising agent (electrolyte), which makes it possible to lower the temperature at which the PU begins to coagulate (gelation temperature or “cloud point”). An example of a destabilising agent is halides and calcium and magnesium sulphates, preferably CaCl₂, MgCl₂ and MgSO₄. The selected agent can be used in an amount of between 0.01% and 8% by weight, more preferably between 1% and 6% in the case of steam coagulation, whereas if hot water at a temperature higher than 90° C. is used, the percentage of salt must be around 20-30% of the PU alone to avoid the polymer's dispersion in water.

Hot water coagulation, compared to steam coagulation, is particularly recommended when it is desired to improve the softness of the final product. Another example of a destabilising agent is acids added to the coagulation solution which bring about the protonation of the anionic groups present in the polyurethane chain (introduced during synthesis, by adding the ionomers together with the polyols and isocyanate). Such acids can be selected, for example, from organic acids such as formic, acetic, oxalic, maleic, or citric acid, or inorganic acids such as hydrochloric, sulphuric, or phosphoric acid. Comparing the hot air coagulation and water coagulation process, the former is more economical and simpler, especially because of the addition of salt into the PU formulation, which introduces the destabilisation of the PU at lower temperatures.

In order to ensure the stability of the PU emulsion during the process, minimise the migration of the polyurethane during the impregnation and coagulation process and/or minimise the loss of polyurethane in the coagulation tank, a thickening agent capable of increasing the viscosity of the preparation can also be added to preparation containing PU. Preferably, the thickener is of the associative type, i.e. capable of being associated with the PU present in the aqueous dispersion already in the form of micelles and thus of producing more complex dispersed structures in which the micelles are aggregated together. The functioning of these associative systems is well known to the person skilled in the art.

Another type of particularly effective thickeners is polyacrylates, which not only increase the viscosity of the preparation, but also induce a modification of the structure of the coagulated polyurethane with the formation of irregular and partially porous surfaces.

Mixtures of these two types of thickeners, which act simultaneously on both phases of the dispersion (water and polyurethane), are also particularly effective. In the case of the hot air coagulation described in the invention, it is possible to avoid the use of thickeners, since the mechanical stirring in storage tanks is already sufficient to ensure the stability of the preparation, with a reduction in the costs of the material obtained as well as a softer hand, as it is known that thickeners can generally increase the stiffness of the materials produced (those of an acrylic type, in particular, impart stiffness to the polyurethane to which they are added).

Alternatively, one may also use additives that increase the viscosity of the dispersing medium (water), thus making it difficult for the polyurethane to migrate through the microfibrous substrate during the drying or coagulation process. Belonging to this category are derivatives of acrylic acid (such as, for example, polyacrylates or urethane/acrylic resins), additives such as synthetic polymers like PVA, compounds derived from natural polymers, such as carboxymethylcellulose (CMC) and some complex sugars such as, for example, xanthan. Associative thickeners and acrylic thickeners, added pure or in a mixture, are particularly preferred.

Advantageously, it is also possible to use PU emulsions or dispersions in water with a higher viscosity (i.e. with a viscosity above the established limits) if non-Newtonian thickeners are chosen. Such non-Newtonian thickeners, in fact, have properties of temporarily reducing the viscosity of the polyurethane emulsion or aqueous dispersion during the impregnation step carried out with pressing rollers. This temporary loss of viscosity occurs because of the strong stresses present in the pressing rollers. At the end of the impregnation and the associated stress, the viscosity of the polyurethane emulsion or aqueous dispersion increases again, thus preventing the migration of the polyurethane onto the surface.

In order to obtain the desired mechanical characteristics and resistance to solvents, the impregnation of steps 1) and 4) takes place in the presence of a cross-linking agent that is capable of being activated during the step of drying the PU at a temperature between about 60° C. and 200° C., preferably between about 70° C. and 160° C.; the cross-linking time is generally less than 5 minutes at the aforesaid temperatures and generally tends to be completed within the next 24 hours.

The cross-linking agent is preferably used in amounts of between 1 and 10%, preferably between 3 and 7% relative to the solid polyurethane content, and can be selected from: melamine, aziridines, epoxides, zirconium compounds, carbodiimides, isocyanate derivatives or, preferably, blocked isocyanate or polyisocyanate with a low deblocking temperature (temperature at which some particularly stable groups are freed from the molecule, thus regenerating the isocyanic group, which can react again with the polyurethane chains present). Carbodiimides and blocked isocyanates are particularly preferred, because they make it possible to obtain a greater control over the process and a greater stability of the dispersions. The cross-linking process can also be activated or assisted by UV rays, if the cross-linking agent or other additives are capable of absorbing UV rays, thereby triggering the process. The fixing process can be preceded by radiation with IR lamps or radiofrequency or microwaves in order to rapidly preheat the polyurethane dispersion, thus facilitating fixing in the more internal layers, far from the surface. Among these pretreatments, the step with IR lamps is particularly preferable, because this type of radiation acts from the surface over the whole mass of polyurethane in such a way as to control migration along the thickness thereof. Direct microwave or radiofrequency drying, with a power of between 5 and 20 KW, can also be taken into consideration.

The polyurethane can also be pigmented with carbon black or other fillers of micro-nano dimensions, nanofibres and nanotubes in order to impart a colour to the finished product which limits the perception of the polyurethane after dyeing.

The final nonwoven fabric is then dried in a hot air oven and subjected to the subsequent production steps, which are, respectively, cutting in two along the section, sueding, dyeing and finishing. The operating conditions of these production steps reflect those used in the production of nonwoven fabric.

With the process of the invention, one obtains a nonwoven microfibre suede-like fabric comprising:
(i) a microfibrous material comprising ultra-fine fibres, in which the average diameter of a single fibre is between 0.1 μm and 10.0 μm, and polyurethane; and in which
(ii) any cross section transverse to the thickness of the microfibrous material has a plurality of regions occupied by the polyurethane that are in contact with the section being observed, each having a cross-sectional area≥50 μm² (independent regions), the total area of the independent regions being between 5.5% and 40.0% of the total field of view.

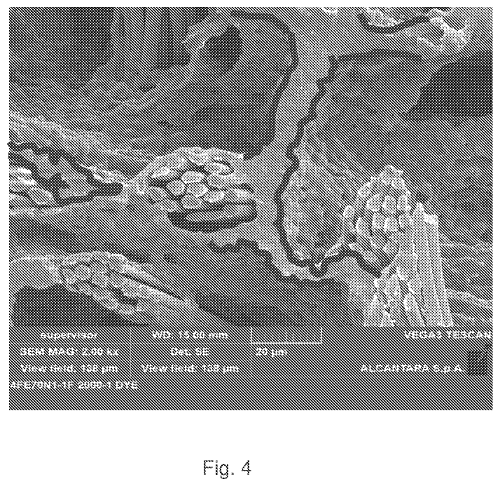

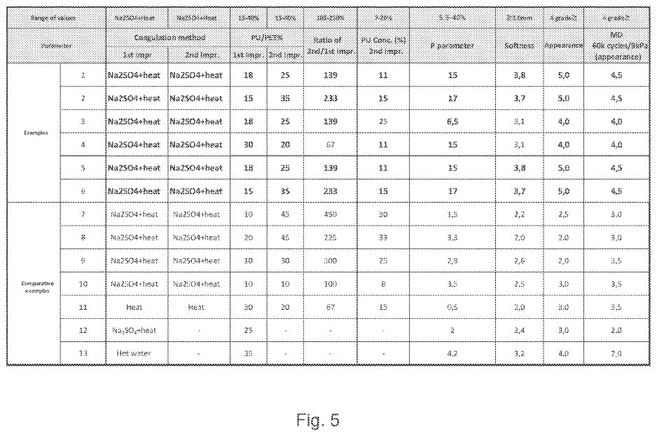

The feature as per point (ii) is calculated by cutting a cross-section sample of nonwoven fabric transversely to the thickness of the nonwoven fabric. This section was observed under a scanning electron microscope (SEM) with ×500 magnification. The images obtained (at least five) were analysed with image processing software capable of calculating the proportion of non-porous polyurethane masses, each with a size≥50 μm², in contact with the cross section. Only the polyurethane regions having an area≥50 μm² and which are in contact with the cross section are included in the calculation of the parameter. If a polyurethane region is below the cross section, it is not considered in the calculation. See FIG. 4, where the areas of polyurethane that are in contact with the cross section and are thus considered in the calculation are indicated with a continuous black line. Furthermore, the total percentage area is calculated relative to the area of the visual field obtained with each SEM image, typically 4×10⁴ μm², followed by a calculation of the average of 5 images.

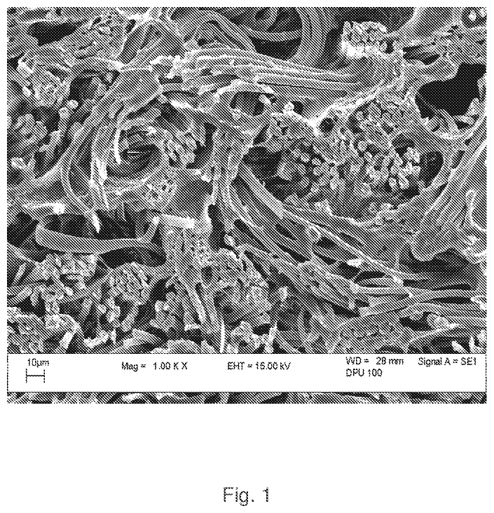

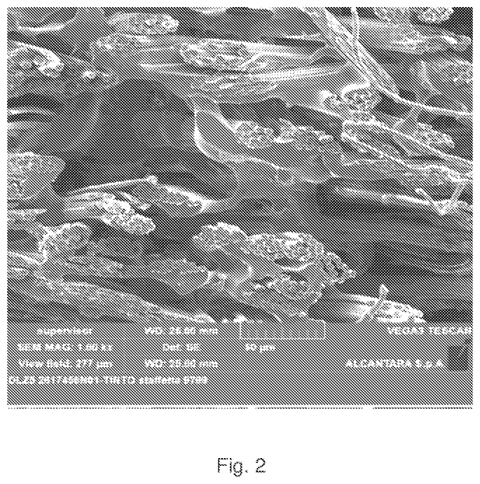

By comparing FIGS. 1 and 2 with FIG. 3, which shows the product obtained with the process of the invention, one can deduce the structural difference existing between the various products. FIG. 1 represents a product obtained with a solvent-based process where the PU has a spongy structure that is not closely linked to the microfibre, thus generating a soft, resistant product (good physical-mechanical properties and abrasion resistance); FIG. 2, by contrast, shows a product with a process without solvents for coagulation, where the PU does not have porosity and is particularly closely linked to the microfibre, thus generating a particularly rigid product; FIG. 3, relating to the invention, represents a PU with a structure with high roughness which, despite the high degree of adhesion to the microfibre, as shown by the SEM photo, gives rise to very soft products with good physical-mechanical properties and abrasion resistance.

### EXAMPLES

The present invention is also described through the following examples.

Further physical and performance parameters are described with the support of the following methods.

### Diameter of a Single Ultra-Fine Fibre

The ultra-fine fibres in the material were observed with 1000× magnification using a scanning electron microscope (SEM, TESCAN VEGA3) and the average value of 20 single fibres randomly selected in a visual field of 30 μm×30 μm.

### Softness of the Material

Based on the method of EN ISO 17235, a non-destructive method for determining the softness of leather, applicable to all non-rigid leathers. For the measurements, use is made of a piston that pushes the sample through a 20 mm hole, and the penetration of the material through the hole itself is measured. The higher the value obtained (penetration of the material into the hole, in mm), the greater the softness.

### Gelation Temperature of the Aqueous Dispersion

20 g of aqueous dispersion were placed in a test tube with an internal diameter of 12 mm; a thermometer was inserted so that the tip was below the level of the liquid; the test tube was then sealed and immersed in a hot water bath at a temperature of 95° C. so that the level of the liquid of the aqueous dispersion was below the level of the liquid in the hot water bath. While the thermometer checked the increase in temperature inside the test tube, the latter was raised, if necessary, and shaken for 5 seconds or less at every check, in order to examine the presence or absence of fluidity on the surface of the aqueous dispersion. The temperature at which the aqueous dispersion loses fluidity on the surface is defined as the gelation temperature of the aqueous dispersion. This measurement is made in triplicate for every type of aqueous dispersion and then calculated as an average.

### Appearance of the Material

The surface appearance of the material obtained was evaluated with a quality inspector, according to the following criteria. The evaluation of surface appearance was made by placing the material on an inspection table in a position parallel to the surface of the floor and visually inspecting the material in sheets with a 45° angle relative to the plane of the inspection table and a distance of 50 cm between the quality inspector and the material. Furthermore, LED lamps were installed on the inspection table at 100 cm from the upper surface of the inspection table in a vertical direction. Grade 4 and grade 5 were considered good.
Grade 5: one observes a uniform nap, the state of dispersion of the fibres is good and the appearance is good.
Grade 4: the material is evaluated as between Grade 5 and Grade 3.
Grade 3: the fibre distribution is not homogeneous; some fibres are not well separated; overall the nap is present and the appearance is fairly good.
Grade 2: the material is evaluated as between Grade 3 and Grade 1.
Grade 1: there are few fibres and the state of dispersion of the fibres overall is very poor and the appearance is of poor quality.

### Evaluation of Abrasion of the Material

For the evaluation of abrasion, use was made of the Martindale Abrasion and Pilling Tester “Model 406”, manufactured by James H. Heal & Co. Ltd. “ABRASIVE CLOTH SM 25”, produced by James H. Heal & Co. Ltd., was used as a certified standard textile. As regards the evaluation criteria, a 5-grade scale was applied with 0.5 intervals, comparing the results with the standard images. No change in appearance compared to the one prior to the abrasion test was evaluated as grade 5, whereas a sheet of material that showed 30 or more pills with a diameter of 1 mm or more, after the abrasion test, was evaluated as grade 1. The photographic scale of the standards was applied to evaluate appearance after the abrasion test.

The weight loss after Martindale was calculated with the following equation. Weight loss (mg)=mass before abrasion (mg)−mass after abrasion (mg).

### Method for Calculating the Percentage Represented by the Masses of Non-Porous Polyurethane (P Parameter)

A sample of artificial leather was cut lengthwise or widthwise and a cross section of the thickness of the artificial leather was observed by scanning electron microscopy (SEM) with ×500 magnification using a scanning electron microscope (SEM TESCAN VEGA3). The images (5 in each case) were analysed with image processing software (NIKON NIS ELEMENTS) capable of calculating the proportion of non-porous polyurethane masses, each ≥50 μm² in size, which are in contact with the cross section being observed among all the polyurethane masses observed in the cross section, and determining the ratio of this area to the total cross section of the nonwoven fabric contained in the visual field (4×10⁴ μm²) in each SEM image, followed by a calculation of the average of 5 images. The parts behind the cross section (not in contact with the section itself) are not included in the calculation (see FIG. 4).

### Example 1

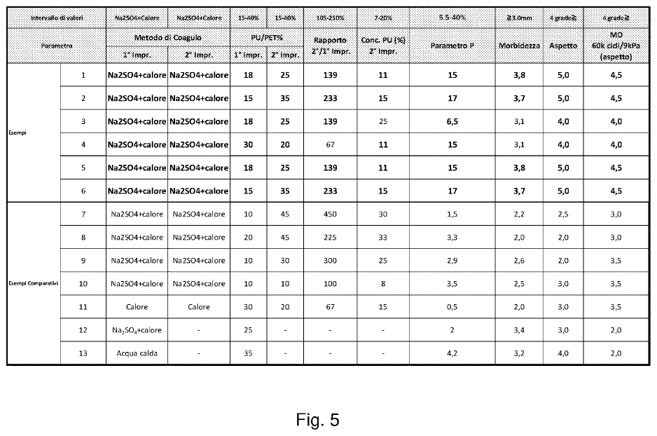

Felt preparation—a composite sea-island fibre with a ratio of 43% by mass of a sea component and 57% by mass of an island component, a number of islands equal to 16 islands/filament and an average fibre diameter of 22 μm was obtained using TLAS as the sea component and polyethylene terephthalate (PET) as the island component. The composite sea-island fibre obtained was cut into a staple having a length of 51 mm, the staple was passed over a card and a cross lapper to form a fibre mat and transformed into nonwoven fabric by needle punching. The nonwoven fabric thus obtained was immersed in hot water at a temperature of 80° C. for 3 minutes and then dried at a temperature of 100° C. for 5 minutes.
First impregnation—45 parts by mass of sodium sulphate (indicated as “Na₂SO₄” in Table 1 in FIG. 5) as a thermosensitive coagulating salt and 7.5 parts by mass of a carbodiimide-based cross-linking agent were added to 100 parts by mass of polyether-based polyurethane and the entire mixture was adjusted to a polyurethane component content of 8% by mass as dry content, using water. The gelation temperature, as measured in the laboratory, was 65° C.

The fibrous nonwoven fabric was immersed in the aqueous dispersion of polyurethane, sodium sulphate and carbodiimide, and then fixed with a hot air dryer at a temperature of 160° C. for 20 minutes to obtain an impregnated fibrous intermediate in which the polyurethane content is equal to 18% by mass of the weight of the fibre.
Dissolution of the sea component—the impregnated fibrous intermediate obtained was immersed in a solution of 8% sodium hydroxide by weight at 63° C. for 8 minutes, in order to remove the sea component from the fibre. After washing with water to remove the residues of the sodium hydroxide solution from the material, a partially impregnated microfibrous intermediate was obtained.
Second impregnation—32 parts by mass of sodium sulphate as a thermosensitive coagulant and 7.5 parts by mass of a carbodiimide-based cross-linking agent were added to 100 parts by mass of polyether-based polyurethane and the entire mixture was adjusted to a polyurethane component content of 11% by mass as dry content, using water. The gelation temperature, as measured in the laboratory, was 65° C.

The microfibrous material obtained was immersed in the aqueous dispersion and then fixed with a hot air dryer at a temperature of 160° C. for 20 minutes to obtain a nonwoven microfibre product in which the polyurethane content originating from the second impregnation is equal to 25% by mass of the weight of the fibres and the total polyurethane content (first+second impregnation) is equal to 43% by mass of the weight of the fibre.

The ratio of the 1^{st} to the 2^{nd} impregnation in terms of polyurethane content is 139%.

The nonwoven microfibre fabric obtained was cut in half in a direction perpendicular to the direction of the thickness and sueded with sandpapers in order to create a finish on the surface and a final thickness of 0.75 mm.

The nonwoven suede-like fabric obtained was dyed with disperse dyes using a jet dying machine under temperature conditions of 120° C., followed by a reduction cleaning step with sodium hydrosulphite in an alkaline solution at 80° C. to remove all the dyes not fixed to the fibre.

The dyed material obtained has a softness of 3.3 mm, a grade 5 surface appearance, and a grade 4.5 Martindale abrasion resistance at 60 kcycles/9 kPa. This material can be applied in the fashion and accessories industry.

In order to improve its softness, the dyed material was subjected to mechanical softening treatments, thereby obtaining a softness value equal to 3.8 mm.

The cross-section area measured by SEM on dyed, softened material showed a P parameter of 15%.

### Example 2

Felt preparation—a composite sea-island fibre with a ratio of 43% by mass of a sea component and 57% by mass of an island component, a number of islands of 16 islands/filament and an average fibre diameter of 22 μm was obtained using TLAS as the sea component and polyethylene terephthalate as the island component. The composite sea-island fibre obtained was cut into a staple having a length of 51 mm; the staple was passed over a card and a cross lapper to form a fibre mat and transformed into nonwoven fabric by needle punching. The nonwoven fabric thus obtained was immersed in hot water at a temperature of 80° C. for 3 minutes and then dried at a temperature of 100° C. for 5 minutes.
First impregnation—45 parts by mass of sodium sulphate (indicated as “Na₂SO₄” in Table 1 in FIG. 5) as a thermosensitive coagulating salt and 7.5 parts by mass of a carbodiimide-based cross-linking agent were added to 100 parts by mass of polyether-based polyurethane and the entire mixture was adjusted to a polyurethane component content of 8% by mass as dry content, using water. The gelation temperature, as measured in the laboratory, was 65° C.

The fibrous nonwoven was immersed in the aqueous dispersion and then fixed with a hot air dryer at a temperature of 160° C. for 20 minutes to obtain an impregnated fibrous intermediate in which the polyurethane content is equal to 15% by mass of the weight of the fibre.

Removal of the sea component—the impregnated microfibrous intermediate obtained was immersed in a solution of 8% sodium hydroxide by weight at 63° C. for 8 minutes, in order to remove the sea component from the fibre.

After washing with water to remove the residues of the sodium hydroxide solution from the material, a partially impregnated microfibrous intermediate was obtained.
Second impregnation—32 parts by mass of sodium sulphate as a thermosensitive coagulant and 7.5 parts by mass of a carbodiimide-based cross-linking agent were added to 100 parts by mass of polyether-based polyurethane and the entire mixture was adjusted to a polyurethane component content of 15% by mass as dry content, using water. The gelation temperature, as measured in the laboratory, was 65° C.

The microfibrous base material obtained was immersed in the aqueous dispersion and then fixed with a hot air dryer at a temperature of 160° C. for 20 minutes to obtain a nonwoven microfibre product in which the polyurethane content originating from the second impregnation is equal to 35% by mass of the weight of the fibres and the total polyurethane content is equal to 50% by mass of the weight of the fibre.

The ratio of the 1^{st} to the 2^{nd} impregnation in terms of polyurethane content is 233%.

The nonwoven microfibre fabric obtained was cut in half in a direction perpendicular to the direction of the thickness and sueded with sandpapers in order to create a finish on the surface and a final thickness of 0.75 mm.

The nonwoven suede-like fabric obtained was dyed with disperse dyes using a jet dying machine under temperature conditions of 120° C., followed by a reduction cleaning step with sodium hydrosulphite in an alkaline solution at 80° C. to remove all the dyes not fixed to the fibre.

The dyed material obtained had a softness of 3.2 mm, a grade 5 surface appearance, and a grade 4.5 Martindale abrasion resistance at 60 kcycles/9 kPa.

This material can be applied in the fashion and accessories industry.

In order to improve its softness, the dyed material was subjected to mechanical softening treatments, thereby obtaining a softness value equal to 3.7 mm.

The cross-section area measured by SEM on dyed, softened material showed a P parameter of 17%.

### Example 3

Felt preparation—a composite sea-island fibre with a ratio of 43% by mass of a sea component and 57% by mass of an island component, a number of islands equal to 16 islands/filament and an average fibre diameter of 22 μm was obtained using TLAS as the sea component and polyethylene terephthalate as the island component. The composite sea-island fibre obtained was cut into a staple having a length of 51 mm, the staple was passed over a card and a cross lapper to form a fibre mat and transformed into nonwoven fabric by needle punching. The nonwoven fabric thus obtained was immersed in hot water at a temperature of 80° C. for 3 minutes and then dried at a temperature of 100° C. for 5 minutes.
First impregnation—45 parts by mass of sodium sulphate (indicated as “Na₂SO₄” in Table 1 in FIG. 5) as a thermosensitive coagulant and 7.5 parts by mass of a carbodiimide-based cross-linking agent were added to 100 parts by mass of polyether-based polyurethane and the entire mixture was adjusted to a polyurethane component content equal to 8% by mass as dry content, using water. The gelation temperature, as measured in the laboratory, was 64° C.

The partially impregnated fibrous nonwoven obtained was immersed in the aqueous dispersion and then fixed with a hot air dryer at a temperature of 160° C. for 20 minutes to obtain an impregnated fibrous intermediate in which the polyurethane content is equal to 18% by mass of the weight of the fibre.
Removal of the sea component—the impregnated fibrous intermediate obtained was immersed in a solution of 8% sodium hydroxide by weight at 63° C. for 8 minutes, in order to remove the sea component from the fibre.

After washing with water to remove the residues of the sodium hydroxide solution from the material, a partially impregnated microfibrous intermediate was obtained.
Second impregnation—32 parts by mass of sodium sulphate as a thermosensitive coagulant and 7.5 parts by mass of a carbodiimide-based cross-linking agent were added to 100 parts by mass of polyether-based polyurethane and the entire mixture was adjusted to a polyurethane component content of 25% by mass as dry content, using water. The gelation temperature, as measured in the laboratory, was 64° C.

The microfibrous base material obtained was immersed in the aqueous dispersion and then fixed with a hot air dryer at a temperature of 160° C. for 20 minutes to obtain a nonwoven microfibre product in which the polyurethane content originating from the second impregnation is equal to 25% by mass of the weight of the fibres and the total polyurethane content is equal to 43% by mass of the weight of the fibre.

The ratio of the 1^{st} to the 2^{nd} impregnation in terms of polyurethane content is 139%.

The nonwoven microfibre fabric obtained was cut in half in a direction perpendicular to the direction of the thickness and sueded with sandpapers in order to create a finish on the surface and a final thickness of 0.75 mm.

The nonwoven suede-like fabric obtained was dyed with disperse dyes using a jet dying machine under temperature conditions of 120° C., followed by a reduction cleaning step with sodium hydrosulphite in an alkaline solution at 80° C. to remove all the dyes not fixed to the fibre.

The dyed material obtained had a softness of 2.8 mm, a grade 4 surface appearance, and a grade 4.0 Martindale abrasion resistance at 60 kcycles/9 kPa.

This material can be applied in the fashion and accessories industry.

In order to improve its softness, the dyed material was subjected to mechanical softening treatments, thereby obtaining a softness value equal to 3.1 mm.

The cross-section area measured by SEM on dyed, softened material showed a P parameter of 6.5%.

### Example 4

Felt preparation—a composite sea-island fibre with a ratio of 43% by mass of a sea component and 57% by mass of an island component, a number of islands equal to 16 islands/filament and an average fibre diameter of 22 μm was obtained using TLAS as the sea component and polyethylene terephthalate as the island component. The composite sea-island fibre obtained was cut into a staple having a length of 51 mm, the staple was passed over a card and a cross lapper to form a fibre mat and transformed into nonwoven fabric by needle punching. The nonwoven fabric thus obtained was immersed and contracted in hot water at a temperature of 80° C. for 3 minutes and then dried at a temperature of 100° C. for 5 minutes.
First impregnation—45 parts by mass of sodium sulphate (indicated as “Na₂SO₄” in Table 1 in FIG. 5) as a thermosensitive coagulant and 7.5 parts by mass of a carbodiimide-based cross-linking agent were added to 100 parts by mass of polyether-based polyurethane and the entire mixture was adjusted to a polyurethane component content of 11% by mass as dry content, using water. The gelation temperature, as measured in the laboratory, was 65° C.

The fibrous nonwoven obtained was immersed in the aqueous dispersion and then fixed with a hot air dryer at a temperature of 160° C. for 20 minutes to obtain an impregnated fibrous intermediate in which the polyurethane content is equal to 30% by mass of the weight of the fibre.
Removal of the sea component—the impregnated fibrous intermediate obtained was immersed in a solution of 8% sodium hydroxide by weight at 63° C. for 8 minutes, in order to remove the sea component from the fibre.

After washing with water to remove the residues of the sodium hydroxide solution from the material, a partially impregnated microfibrous intermediate was obtained.
Second impregnation—32 parts by mass of sodium sulphate as a thermosensitive coagulant and 7.5 parts by mass of a carbodiimide-based cross-linking agent were added to 100 parts by mass of polyether-based polyurethane and the entire mixture was adjusted to a polyurethane component content of 11% by mass as dry content, using water. The gelation temperature, as measured in the laboratory, was 64° C.

The microfibrous base material obtained was immersed in the aqueous dispersion and then fixed with a hot air dryer at a temperature of 160° C. for 20 minutes to obtain a nonwoven microfibre product in which the polyurethane content originating from the second impregnation is equal to 20% by mass of the weight of the fibres and the total polyurethane content is equal to 50% by mass of the weight of the fibre.

The ratio of the 1^{st} to the 2^{nd} impregnation in terms of polyurethane content is 67%.

The nonwoven microfibre fabric obtained was cut in half in a direction perpendicular to the direction of the thickness and sueded with sandpapers in order to create a finish on the surface and a final thickness of 0.75 mm.

The nonwoven suede-like fabric obtained was dyed with disperse dyes using a jet dying machine under temperature conditions of 120° C., followed by a reduction cleaning step with sodium hydrosulphite in an alkaline solution at 80° C. to remove all the dyes not fixed to the fibre.

The dyed material obtained had a softness of 2.8 mm, a grade 4 surface appearance, and a grade 4.0 Martindale abrasion resistance at 60 kcycles/9 kPa.

This material can be applied in the fashion and accessories industry.

In order to improve its softness, the dyed material was subjected to mechanical softening treatments, thereby obtaining a softness value equal to 3.1 mm.

The cross-section area measured by SEM on dyed, softened material showed a P parameter of 15%.

### Example 5

Like in example 1, in which the composite sea-island fibre had a ratio of 30% by mass of a sea component and 70% by mass of an island component, a number of islands of 16 islands/filament and an average fibre diameter of 22 μm, it was obtained using TLAS as the sea component and polyethylene terephthalate as the island component.

The dyed material obtained had a softness of 3.4 mm, a grade 5 surface appearance, and a grade 4.5 Martindale abrasion resistance at 60 kcycles/9 kPa.

This material can be applied in the automotive industry for covering car seats and ceilings.

In order to improve its softness, the dyed material was subjected to mechanical softening treatments, thereby obtaining a softness value equal to 3.8 mm.

The cross-section area measured by SEM on dyed, softened material showed a P parameter of 15%.

### Example 6

Like in example 2, in which the composite sea-island fibre had a ratio of the 30% by mass of a sea component and of the 70% by mass of an island component, a number of islands equal to 16 islands/filament and an average fibre diameter of 22 μm, it was obtained using TLAS as the sea component and polyethylene terephthalate as the island component.

The dyed material obtained had a softness of 3.3 mm, a grade 5 surface appearance, and a grade 4.5 Martindale abrasion resistance at 60 kcycles/9 kPa.

This material can be applied in the automotive industry for covering car seats and ceilings.

In order to improve its softness, the dyed material was subjected to mechanical softening treatments, thereby obtaining a softness value equal to 3.7 mm.

The cross-section area measured by SEM on dyed, softened material showed a P parameter of 17%.

### Comparative Example 7

Felt preparation—a composite sea-island fibre with a ratio of 43% by mass of a sea component and 57% by mass of an island component, a number of islands of 16 islands/filament and an average fibre diameter of 22 μm was obtained using TLAS as the sea component and polyethylene terephthalate as the island component. The composite sea-island fibre obtained was cut into a staple having a length of 51 mm, the staple was passed over a card and a cross lapper to form a fibre mat and transformed into nonwoven fabric by needle punching. The nonwoven fabric thus obtained was immersed in hot water at a temperature of 80° C. for 3 minutes and then dried at a temperature of 100° C. for 5 minutes.
First impregnation—45 parts by mass of sodium sulphate (indicated as “Na₂SO₄” in Table 1 in FIG. 5) as a thermosensitive coagulant and 7.5 parts by mass of a carbodiimide-based cross-linking agent were added to 100 parts by mass of polyether-based polyurethane and the entire mixture was adjusted to a polyurethane component content of 8% by mass as dry content, using water. The gelation temperature, as measured in the laboratory, was 63° C.

The fibrous nonwoven was immersed in the aqueous dispersion and then fixed with a hot air dryer at a temperature of 160° C. for 20 minutes to obtain an impregnated fibrous intermediate in which the polyurethane content is equal to 10% by mass of the weight of the fibre.
Removal of the sea component—the impregnated fibrous intermediate obtained was immersed in a solution of 8% sodium hydroxide by weight at 63° C. for 8 minutes, in order to remove the sea component from the fibre.

After washing with water to remove the residues of the sodium hydroxide solution from the material, a partially impregnated microfibrous intermediate was obtained.
Second impregnation—32 parts by mass of sodium sulphate as a thermosensitive coagulant and 7.5 parts by mass of a carbodiimide-based cross-linking agent were added to 100 parts by mass of polyether-based polyurethane and the entire mixture was adjusted to a polyurethane component content of 30% by mass as dry content, using water. The gelation temperature, as measured in the laboratory, was 63° C.

The microfibrous base material obtained was immersed in the aqueous dispersion and then fixed with a hot air dryer at a temperature of 160° C. for 20 minutes to obtain a nonwoven microfibre product in which the polyurethane content originating from the second impregnation is equal to 45% by mass of the weight of the fibres and the total polyurethane content is equal to 55% by mass of the weight of the fibre.

The ratio of the 1^{st} to the 2^{nd} impregnation in terms of polyurethane content is 450%.

The nonwoven microfibre fabric obtained was cut in half in a direction perpendicular to the direction of the thickness and sueded with sandpapers in order to create a finish on the surface and a final thickness of 0.75 mm.

The nonwoven suede-like fabric obtained was dyed with disperse dyes using a jet dying machine under temperature conditions of 120° C., followed by a reduction cleaning step with sodium hydrosulphite in an alkaline solution at 80° C. to remove all the dyes not fixed to the fibre.

The dyed material obtained had a softness of 2.0 mm, a grade 2.5 surface appearance, and a grade 3.0 Martindale abrasion resistance at 60 kcycles/9 kPa.

This material can be applied in the fashion and accessories industry.

In order to improve its softness, the dyed material was subjected to mechanical softening treatments, thereby obtaining a softness value equal to 2.2 mm.

The cross-section area measured by SEM on dyed, softened material showed a P parameter of 1.5%.

### Comparative Example 8

Felt preparation—a composite sea-island fibre with a ratio of 43% by mass of a sea component and 57% by mass of an island component, a number of islands equal to 16 islands/filament and an average fibre diameter of 22 μm was obtained using TLAS as the sea component and polyethylene terephthalate as the island component. The composite sea-island fibre obtained was cut into a staple having a length of 51 mm, the staple was passed over a card and a cross lapper to form a fibre mat and transformed into nonwoven fabric by needle punching. The nonwoven fabric thus obtained was immersed and contracted in hot water at a temperature of 80° C. for 3 minutes and then dried at a temperature of 100° C. for 5 minutes.
First impregnation—45 parts by mass of sodium sulphate (indicated as “Na₂SO₄” in Table 1 in FIG. 5) as a thermosensitive coagulant and 7.5 parts by mass of a carbodiimide-based cross-linking agent were added to 100 parts by mass of polyether-based polyurethane and the entire mixture was adjusted to a polyurethane component content of 8% by mass as dry content, using water. The gelation temperature, as measured in the laboratory, was 65° C.

The microfibrous nonwoven was immersed in the aqueous dispersion and then fixed with a hot air dryer at a temperature of 160° C. for 20 minutes to obtain an impregnated microfibrous intermediate in which the polyurethane content is equal to 20% by mass of the weight of the fibre.
Removal of the sea component—the impregnated fibrous intermediate obtained was immersed in a solution of 8% sodium hydroxide by weight at 63° C. for 8 minutes, in order to remove the sea component from the fibre.

After washing with water to remove the residues of the sodium hydroxide solution from the material, a partially impregnated microfibrous intermediate was obtained.
Second impregnation—32 parts by mass of sodium sulphate as a thermosensitive coagulant and 7.5 parts by mass of a carbodiimide-based cross-linking agent were added to 100 parts by mass of polyether-based polyurethane and the entire mixture was adjusted to a polyurethane component content of 33% by mass as dry content, using water. The gelation temperature, as measured in the laboratory, was 65° C.

The microfibrous base material obtained was immersed in the aqueous dispersion and then fixed with a hot air dryer at a temperature of 160° C. for 20 minutes to obtain a nonwoven microfibre product in which the polyurethane content originating from the second impregnation is equal to 45% by mass of the weight of the fibres and the total polyurethane content is equal to 65% by mass of the weight of the fibre.

The ratio of the 1^{st} to the 2^{nd} impregnation in terms of polyurethane content is 225%.

The nonwoven microfibre fabric obtained was cut in half in a direction perpendicular to the direction of the thickness and sueded with sandpapers in order to create a finish on the surface and a final thickness of 0.75 mm.

The nonwoven suede-like fabric obtained was dyed with disperse dyes using a jet dying machine under temperature conditions of 120° C., followed by a reduction cleaning step with sodium hydrosulphite in an alkaline solution at 80° C. to remove all the dyes not fixed to the fibre.

The dyed material obtained had a softness of 1.8 mm, a grade 2 surface appearance, and a grade 3.0 Martindale abrasion resistance at 60 kcycles/9 kPa.

This material can be applied in the fashion and accessories industry.

In order to improve its softness, the dyed material was subjected to mechanical softening treatments, thereby obtaining a softness value equal to 2.0 mm.

The cross-section area measured by SEM on dyed, softened material showed a P parameter of 3.3%.

### Comparative Example 9

Felt preparation—a composite sea-island fibre with a ratio of 43% by mass of a sea component and 57% by mass of an island component, a number of islands equal to 16 islands/filament and an average fibre diameter of 22 μm was obtained using TLAS as the sea component and polyethylene terephthalate as the island component.

The composite sea-island fibre obtained was cut into a staple having a length of 51 mm, the staple was passed over a card and a cross lapper to form a fibre mat and transformed into nonwoven fabric by needle punching. The nonwoven fabric thus obtained was immersed and contracted in hot water at a temperature of 80° C. for 3 minutes and then dried at a temperature of 100° C. for 5 minutes.

First impregnation—45 parts by mass of sodium sulphate (indicated as “Na₂SO₄” in Table 1 in FIG. 5) as a thermosensitive coagulant and 7.5 parts by mass of a carbodiimide-based cross-linking agent were added to 100 parts by mass of polyether-based polyurethane and the entire mixture was adjusted to a polyurethane component content of 8% by mass as dry content, using water. The gelation temperature, as measured in the laboratory, was 64° C.

The fibrous nonwoven obtained was immersed in the aqueous dispersion and then fixed with a hot air dryer at a temperature of 160° C. for 20 minutes to obtain an impregnated fibrous intermediate in which the polyurethane content is equal to 10% by mass of the weight of the fibre.

Removal of the sea component—the impregnated fibrous intermediate obtained was immersed in a solution of 8% sodium hydroxide by weight at 63° C. for 8 minutes, in order to remove the sea component from the fibre.

After washing with water to remove the residues of the sodium hydroxide solution from the material, a partially impregnated microfibrous intermediate was obtained.
Second impregnation—32 parts by mass of sodium sulphate as a thermosensitive coagulant and 7.5 parts by mass of a carbodiimide-based cross-linking agent were added to 100 parts by mass of polyether-based polyurethane and the entire mixture was adjusted to a polyurethane component content of 25% by mass as dry content, using water. The gelation temperature, as measured in the laboratory, was 65° C.

The microfibrous base material obtained was immersed in the aqueous dispersion and then fixed with a hot air dryer at a temperature of 160° C. for 20 minutes to obtain a nonwoven microfibre product in which the polyurethane content originating from the second impregnation is equal to 30% by mass of the weight of the fibres and the total polyurethane content is equal to 40% by mass of the weight of the fibre.

The ratio of the 1^{st} to the 2^{nd} impregnation in terms of polyurethane content is 300%.

The nonwoven microfibre fabric obtained was cut in half in a direction perpendicular to the direction of the thickness and sueded with sandpapers in order to create a finish on the surface and a final thickness of 0.75 mm.

The nonwoven suede-like fabric obtained was dyed with disperse dyes using a jet dying machine under temperature conditions of 120° C., followed by a reduction cleaning step with sodium hydrosulphite in an alkaline solution at 80° C. to remove all the dyes not fixed to the fibre.

The dyed material obtained had a softness of 2.3 mm, a grade 2 surface appearance, and a grade 3.5 Martindale abrasion resistance at 60 kcycles/9 kPa.

This material can be applied in the fashion and accessories industry.

In order to improve its softness, the dyed material was subjected to mechanical softening treatments, thereby obtaining a softness value equal to 2.6 mm.

The cross-section area measured by SEM on dyed, softened material showed a P parameter of 2.9%.

### Comparative Example 10

Felt preparation—a composite sea-island fibre with a ratio of 43% by mass of a sea component and 57% by mass of an island component, a number of islands of 16 islands/filament and an average fibre diameter of 22 μm was obtained using TLAS as the sea component and polyethylene terephthalate as the island component. The composite sea-island fibre obtained was cut into a staple having a length of 51 mm, the staple was passed over a card and a cross lapper to form a fibre mat and transformed into nonwoven fabric by needle punching. The nonwoven fabric thus obtained was immersed in hot water at a temperature of 80° C. for 3 minutes and then dried at a temperature of 100° C. for 5 minutes.

First impregnation—45 parts by mass of sodium sulphate (indicated as “Na2SO4” in Table 1 in FIG. 5) as a thermosensitive coagulant and 7.5 parts by mass of a carbodiimide-based cross-linking agent were added to 100 parts by mass of polyether-based polyurethane and the entire mixture was adjusted to a polyurethane component content equal to 8% by mass as dry content, using water. The gelation temperature, as measured in the laboratory, was 65° C.

The partially impregnated fibrous nonwoven obtained was immersed in the aqueous dispersion and then fixed with a hot air dryer at a temperature of 160° C. for 20 minutes to obtain an impregnated fibrous intermediate in which the polyurethane content is equal to 10% by mass of the weight of the fibre.

Removal of the sea component—the impregnated fibrous intermediate obtained was immersed in a solution of 8% sodium hydroxide by weight at 63° C. for 8 minutes, in order to remove the sea component from the fibre.

After washing with water to remove the residues of the sodium hydroxide solution from the material, a partially impregnated microfibrous intermediate was obtained.
Second impregnation—32 parts by mass of sodium sulphate as a thermosensitive coagulant and 7.5 parts by mass of a carbodiimide-based cross-linking agent were added to 100 parts by mass of polyether-based polyurethane and the entire mixture was adjusted to a polyurethane component content of 8% by mass as dry content, using water. The gelation temperature, as measured in the laboratory, was 64° C.

The microfibrous base material obtained was immersed in the aqueous dispersion and then fixed with a hot air dryer at a temperature of 160° C. for 20 minutes to obtain a nonwoven microfibre product in which the polyurethane content originating from the second impregnation is equal to 10% by mass of the weight of the fibres and the total polyurethane content is equal to 20% by mass of the weight of the fibre.

The ratio of the 1^{st} to the 2^{nd} impregnation in terms of polyurethane content is 100%.

The nonwoven microfibre fabric obtained was cut in half in a direction perpendicular to the direction of the thickness and sueded with sandpapers in order to create a finish on the surface and a final thickness of 0.75 mm.

The nonwoven suede-like fabric obtained was dyed with disperse dyes using a jet dying machine under temperature conditions of 120° C., followed by a reduction cleaning step with sodium hydrosulphite in an alkaline solution at 80° C. in order to remove all the dyes not fixed to the fibre.

The dyed material obtained had a softness of 2.3 mm, a grade 3 surface appearance, and a grade 3.5 Martindale abrasion resistance at 60 kcycles/9 kPa.

This material can be applied in the fashion and accessories industry.

In order to improve its softness, the dyed material was subjected to mechanical softening treatments, thereby obtaining a softness value equal to 2.5 mm.

The cross-section area measured by SEM on dyed, softened material showed a P parameter of 3.5%.

### Comparative Example 11

Felt preparation—a composite sea-island fibre with a composite ratio of 43% by mass of a sea component and 57% by mass of an island component, a number of islands equal to 16 islands/filament and an average fibre diameter of 22 μm was obtained using TLAS as the sea component and polyethylene terephthalate as the island component. The composite sea-island fibre obtained was cut into a staple having a length of 51 mm, the staple was passed over a card and a cross lapper to form a fibre mat and transformed into nonwoven fabric by needle punching. The nonwoven fabric thus obtained was immersed and contracted in hot water at a temperature of 80° C. for 3 minutes and then dried at a temperature of 100° C. for 5 minutes.
First impregnation—7.5 parts by mass of a carbodiimide-based cross-linking agent were added to 100 parts by mass of polyether-based polyurethane and the entire mixture was adjusted with water until reaching a polyurethane component content of 15% by mass as dry content. The gelation temperature, as measured in the laboratory, was 65° C.

The partially impregnated fibrous nonwoven obtained was immersed in the aqueous dispersion and then fixed with a hot air dryer at a temperature of 160° C. for 20 minutes to obtain an impregnated fibrous intermediate in which the polyurethane content is equal to 30% by mass of the weight of the fibre.
Removal of the sea component—the impregnated fibrous intermediate obtained was immersed in a solution of 8% sodium hydroxide by weight at 63° C. for 8 minutes in order to remove the sea component from the fibre.

After washing with water to remove the residues of the sodium hydroxide solution from the material, a partially impregnated microfibrous intermediate was obtained.
Second impregnation—7.5 parts by mass of a carbodiimide-based cross-linking agent were added to 100 parts by mass of polyether-based polyurethane and the entire mixture was brought to a polyurethane component content equal to 15% by mass as dry content, using water. The gelation temperature, as measured in the laboratory, was 65° C.

The microfibrous material obtained was immersed in the aqueous dispersion and then fixed with a hot air dryer at a temperature of 160° C. for 20 minutes to obtain a nonwoven microfibre product in which the polyurethane content originating from the second impregnation is equal to 20% by mass of the weight of the fibres and the total polyurethane content is equal to 50% by mass of the weight of the fibre.

The ratio of the 1^{st} to the 2^{nd} impregnation in terms of polyurethane content is 67%.

The nonwoven microfibre fabric obtained was cut in half in a direction perpendicular to the direction of the thickness and sueded with sandpapers in order to create a finish on the surface and a final thickness of 0.75 mm.

The nonwoven suede-like fabric obtained was dyed with disperse dyes using a jet dying machine under temperature conditions of 120° C., followed by a reduction cleaning step with sodium hydrosulphite in an alkaline solution at 80° C. to remove all the dyes not fixed to the fibre.

The dyed material obtained had a softness of 1.8 mm, a grade 3 surface appearance, and a grade 3.5 Martindale abrasion resistance at 60 kcycles/9 kPa.

This material can be applied in the fashion and accessories industry.

In order to improve its softness, the dyed material was subjected to mechanical softening treatments, thereby obtaining a softness value equal to 2.0 mm.

The cross-section area measured by SEM on dyed, softened material showed a P parameter of 0.5%.

### Comparative Example 12

Felt preparation—a composite sea-island fibre with a ratio of 43% by mass of a sea component and 57% by mass of an island component, a number of islands equal to 16 islands/filament and an average fibre diameter of 22 μm was obtained using TLAS as the sea component and polyethylene terephthalate as the island component. The composite sea-island fibre obtained was cut into a staple having a length of 51 mm, the staple was passed over a card and a cross lapper to form a fibre mat and transformed into nonwoven fabric by needle punching. The nonwoven fabric thus obtained was immersed in hot water at a temperature of 80° C. for 3 minutes and then dried at a temperature of 100° C. for 5 minutes.
Impregnation—45 parts by mass of sodium sulphate (indicated as “Na₂SO₄” in Table 1 in FIG. 5) as a thermosensitive coagulant and 7.5 parts by mass of a carbodiimide-based cross-linking agent were added to 100 parts by mass of polyether-based polyurethane and the entire mixture was adjusted to a polyurethane component content of 8% by mass as dry content, using water. The gelation temperature, as measured in the laboratory, was 64° C.

The fibrous nonwoven obtained was immersed in the aqueous dispersion and then fixed with a hot air dryer at a temperature of 160° C. for 20 minutes to obtain an impregnated fibrous intermediate in which the polyurethane content is equal to 25% by mass of the weight of the fibre.
Removal of the sea component—the impregnated fibrous intermediate obtained was immersed in a solution of 8% sodium hydroxide by weight at 63° C. for 8 minutes, in order to remove the sea component from the fibre.

After washing with water to remove the residues of the sodium hydroxide solution from the material, a nonwoven microfibre product was obtained.

The nonwoven microfibre fabric obtained was cut in half in a direction perpendicular to the direction of the thickness and sueded with sandpapers in order to create a finish on the surface and a final thickness of 0.74 mm.

The nonwoven suede-like fabric obtained was dyed with disperse dyes using a jet dying machine under temperature conditions of 120° C., followed by a reduction cleaning step with sodium hydrosulphite in an alkaline solution at 80° C. to remove all the dyes not fixed to the fibre.

The dyed material obtained had a softness of 2.8 mm, a grade 3 surface appearance, and a grade 2.0 Martindale abrasion resistance at 60 kcycles/9 kPa.

This material can be applied in the fashion and accessories industry.

In order to improve its softness, the dyed material was subjected to mechanical softening treatments, thereby obtaining a softness value equal to 3.4 mm.

The cross-section area measured by SEM on dyed, softened material showed a P parameter of 2%.

### Comparative Example 13

Felt preparation—a composite sea-island fibre with a ratio of 43% by mass of a sea component and 57% by mass of an island component, a number of islands equal to 16 islands/filament and an average fibre diameter of 22 μm was obtained using TLAS as the sea component and polyethylene terephthalate as the island component. The composite sea-island fibre obtained was cut into a staple having a length of 51 mm, the staple was passed over a card and a cross lapper to form a fibre mat and transformed into nonwoven fabric by needle punching. The nonwoven fabric thus obtained was immersed and contracted in hot water at a temperature of 80° C. for 3 minutes and then dried at a temperature of 100° C. for 5 minutes.
Impregnation—7.5 parts by mass of a carbodiimide-based cross-linking agent were added to 100 parts by mass of polyether-based polyurethane and the entire mixture was brought to a polyurethane component content equal to 11% by mass as dry content, using water. The gelation temperature, as measured in the laboratory, was 65° C. The impregnated fibrous nonwoven obtained was immersed in the aqueous dispersion and then fixed with a hot air dryer at a temperature of 160° C. for 20 minutes to obtain an impregnated fibrous intermediate in which the polyurethane content is equal to 35% by mass of the weight of the fibre.
Removal of the sea component—the impregnated fibrous intermediate obtained was immersed in a solution of 8% sodium hydroxide by weight at 63° C. for 8 minutes, in order to remove the sea component from the fibre.

After washing with water to remove the residues of the sodium hydroxide solution from the material, a nonwoven microfibre product was obtained.

The nonwoven microfibre fabric obtained was cut in half in a direction perpendicular to the direction of the thickness and sueded with sandpapers in order to create a finish on the surface and a final thickness of 0.74 mm.

The nonwoven suede-like fabric obtained was dyed with disperse dyes using a jet dying machine under temperature conditions of 120° C., followed by a reduction cleaning step with sodium hydrosulphite in an alkaline solution at 80° C. to remove all the dyes not fixed to the fibre.

The dyed material obtained had a softness of 2.6 mm, a grade 4 surface appearance, and a grade 2.0 Martindale abrasion resistance at 60 kcycles/9 kPa.

This material can be applied in the fashion and accessories industry.

In order to improve its softness, the dyed material was subjected to mechanical softening treatments, thereby obtaining a softness value equal to 3.2 mm.

The cross-section area measured by SEM on dyed, softened material showed a P parameter of 4.2%.

FIG. 5 shows a table in which the examples obtained are summarised: the good results and the process parameters responsible for the good performances are highlighted in bold.

1. Process for the preparation of a nonwoven microfibre fabric comprising the steps of:
1) Impregnating a fibrous material comprising ultra-fine fibre-generating fibres with an aqueous dispersion containing polyurethane, an inorganic salt containing monovalent or bivalent positive ions and a cross-linking agent (first impregnation), wherein the polyurethane content is between 15% and 40% by mass relative to the mass of the ultra-fine fibres;
2) fixing the polyurethane onto the impregnated fibrous material (first coagulation step);
3) generating ultrafine fibres from the ultra-fine fibre-generating fibres to form a microfibrous material consisting of ultrafine fibres by treating the fibrous material with an alkaline, acid or neutral aqueous solution; and
4) impregnating the microfibrous material with an aqueous dispersion containing polyurethane, an inorganic salt containing monovalent or bivalent positive ions and a cross-linking agent, in which the polyurethane is between 15% and 40% by mass relative to the mass of the ultrafine fibres (second impregnation); and
5) fixing the polyurethane onto the impregnated fibrous material (second coagulation step),
wherein the ratio of the polyurethane content of the second impregnation to the polyurethane content of the first impregnation is between 100 and 250%.

2. The process according to claim 1, wherein the concentration of the monovalent or bivalent positive ions in both the first and second impregnation is between 10 and 100% by mass relative to the mass of the polyurethane.

3. The process according to claim 1, wherein the impregnation step 1) is preceded by a step a) spinning a bicomponent fibre of the sea-island type, a step b) preparing a fibrous material from the bicomponent fibre and a step c) thermal stabilizing of the fibrous material.

4. The process according to claim 1, wherein in the first impregnation a polyurethane dispersion is present in a concentration between 5 and 20% by weight, which generates an amount of polyurethane between 15% and 40%, or between 18% and 35%—by mass relative to the mass of the ultra-fine fibres of the impregnated material.

5. The process according to claim 1, wherein the inorganic salt containing monovalent positive ions is selected from sodium sulphate or sodium chloride.

6. The process according to claim 5, wherein the salt concentration is between 30 and 100% of the solid weight of the polyurethane.

7. The process according to claim 1, wherein in step 3) the sea component is removed with an aqueous alkaline solution.

8. The process according to claim 1, wherein an aqueous polyurethane dispersion having a concentration between 5% and 20% is present in the second impregnation, which generates an amount of polyurethane between 15% and 40%, or between 20% and 40%—by mass relative to the mass of the ultra-fine fibres of the impregnated intermediate.

9. The process according to claim 1, wherein the fixing of steps 2) and 5) is carried out by air coagulation, hot water coagulation, coagulation in aqueous solutions of electrolytes, radiofrequency coagulation, microwave coagulation, ultrasonic coagulation, coagulation by IR (infrared) radiation or steam coagulation.

10. The process according to claim 1, wherein the crosslinking agent is selected from: melamines, aziridines, epoxides, zirconium compounds, carbodiimides, isocyanate and polyisocyanate locked with low deblocking temperature.

11. Nonwoven microfibre suede-like fabric comprising:
a microfibrous material comprising ultrafine fibres in which the average diameter of a single fibre is between 0.1 μm and 10.0 μm, and polyurethane; and in which any cross section transverse to the thickness of the microfibrous material has a plurality of regions occupied by the polyurethane that are in contact with the section, each having a cross-sectional area≥50 μm² (independent regions), the total area of the independent regions being between 5.5% and 40.0% of the total field of view.

12. The process according to claim 1, wherein the ratio of the polyurethane content of the second impregnation to the polyurethane content of the first impregnation is between 105 and 240%.

13. The process according to claim 4, wherein in the first impregnation a polyurethane dispersion is present in a concentration between 6 and 18% by weight at room temperature, which generates an amount of polyurethane between 15% and 40% or between 18% and 35% by mass relative to the mass of the ultra-fine fibres of the impregnated material.

14. The process according to claim 6, wherein the salt concentration is between 40 and 80%—of the solid weight of the polyurethane.

15. The process according to claim 7, wherein the aqueous alkaline solution, is an aqueous sodium hydroxide solution, an aqueous acid solution or hot water.

16. The process according to claim 8, wherein an aqueous polyurethane dispersion having a concentration between 7 to 20%—at room temperature, is used in the second impregnation, which generates an amount of polyurethane between 15% and 40%, or between 20% and 40%—by mass relative to the mass of the ultra-fine fibres of the impregnated intermediate.

17. The process according to claim 9, wherein the fixing of steps 2) and 5) is carried out by hot air coagulation.
